(19) United States
(12) Patent Application Publication
(10) Pub. No.: US 2014/0287372 A1
(43) Pub. Date: Sep. 25, 2014

(54) POST-HEAT-TREATABLE SUBSTRATE WITH THERMOCHROMIC FILM

(71) Applicant: SAMSUNG CORNING PRECISION MATERIALS CO., LTD., Gumi-si (KR)

(72) Inventors: Youngsoo JUNG, Asan-si (KR); Donggun MOON, Asan-si (KR); Myungi SHIM, Asan-si (KR); Sangryoun RYU, Asan-si (KR)

(21) Appl. No.: 14/299,972

(22) Filed: Jun. 9, 2014

Related U.S. Application Data
(62) Division of application No. 13/449,549, filed on Apr. 18, 2012.

(30) Foreign Application Priority Data
Apr. 18, 2011 (KR) 10-2011-0035790

(51) Int. Cl. C03C 17/34

(52) U.S. Cl. CPC C03C 17/3417
USPC 432/9

(57) ABSTRACT

A post-heat-treatable substrate with a thermochromic film. The post-heat-treatable substrate includes a base substrate, a thermochromic film coating the base substrate, an auxiliary film formed on at least one of the upper surface and the lower surface of the thermochromic film, and a sacrificial film formed between the thermochromic film and the auxiliary film. The sacrificial film is made of metal. Accordingly, the thermochromic material is prevented from agglomerating during post-heat-treatment of the substrate. The auxiliary film prevents oxygen and nitrogen from diffusing into the thermochromic film, so that high-temperature heat treatment, such as a process for tempering the substrate, a process for heat-strengthening the substrate and a process for forming the substrate to become curved, can be conducted on the substrate.

### CROSS REFERENCE TO RELATED APPLICATION

The present application claims priority from Korean Patent Application Number 10-2011-0035790 filed on Apr. 18, 2011, the entire contents of which application are incorporated herein for all purposes by this reference.

### BACKGROUND OF THE INVENTION

1. Field of the Invention

The present invention relates to a post-heat-treatable substrate with a thermochromic film, and more particularly, to a post-heat-treatable substrate with a thermochromic film, and has a sacrificial film on at least one of an upper layer and a lower layer of the thermochromic film.

2. Description of Related Art

In response to soaring prices of chemical energy sources such as petroleum, the necessity for the development of new energy sources is increasing. In addition, the importance of energy saving technologies is increasing just as much as the necessity for new energy sources. In fact, at least 60% of energy consumption in common houses is attributed to heating and/or cooling. In particular, common houses and buildings lose up to 24% of their energy through windows.

Accordingly, a variety of attempts has been made in order to reduce the amount of energy that is lost through windows while maintaining the aesthetics and view characteristics, which are the basic functions of windows. Representative methods, by way of example, include varying the size of windows and furnishing high-insulation windows.

Types of high insulation window glass include a gas injected pair-glass, in which argon (Ar) gas, krypton (Kr) gas, or the like is disposed between a pair of glass sheets in order to prevent heat exchange, low-e glass, which is coated with a conductive material in order to prevent heat from radiating outward from the room, and the like. Also being studied is a type of glass that is coated with a layer that has specific thermal characteristics in order to adjust the introduction of solar energy.

In particular, the low-e glass is coated, on the surface thereof, with a thin layer of metal or metal oxide, which allows most visible light that is incident on the window to enter, so that the interior of a room can be maintained bright, while blocking radiation in the infrared (IR) range. The effects of this glass are that it prevents the heat of heating from leaking to the outside, and also prevents the energy of heat from outside a building, thereby reducing cooling and heating bills. However, this window has the following drawbacks due to its characteristic of reflecting wavelengths other than visible light. Specifically, it does not admit the IR range of sunlight into the interior of a room, which is a drawback especially in winter, and the transmittance of sunlight is not adjusted according to the season (temperature).

Accordingly, the development of a technology that is devised to save cooling and/or heating energy by coating a glass with a thermochromic material is underway. This thermochromic material can selectively transmit or block IR rays, which have strong thermal action.

When a thermochromic coating is applied to the exterior glass of a building, a sunroof, the side and rear windows of a vehicle, or the like, it can save cooling energy in summer by blocking solar heat from outside and save heating energy in winter by allowing solar energy from outside to enter.

However, the above-mentioned coated glass is required to undergo post-heat treatment. Specifically, the glass is implemented as tempered or heat-strengthened glass when it is used in the construction industry. When this glass is used in vehicles, the glass must be subjected to a process for forming it to become curved, such that it conforms to the streamlined shape of a vehicle. Considering the characteristics of the coated glass, its characteristics frequently deteriorate when it is subjected to post-heat treatment at a temperature of about 700° C. The thermochromic coating also has problems in that it has quality defects, such as discoloration, pinholes, hazing, splitting, and image distortion, as the result of post-heat treatment.

The information disclosed in this Background of the Invention section is only for the enhancement of understanding of the background of the invention, and should not be taken as an acknowledgment or any form of suggestion that this information forms a prior art that would already be known to a person skilled in the art.

### BRIEF SUMMARY OF THE INVENTION

Various aspects of the present invention provide a substrate that is post-heat-treatable due to the presence of a sacrificial film made of metal disposed on at least one of an upper layer and a lower layer of a thermochromic film.

In an aspect of the present invention, provided is a post-heat-treatable substrate that includes a base substrate, a thermochromic film coating the base substrate, and a sacrificial film formed on at least one of the upper surface and the lower surface of the thermochromic film, the sacrificial film being made of metal.

In an embodiment, the thermochromic film may be made of vanadium dioxide (VO₂)

In an embodiment, the post-heat-treatable substrate may further include an auxiliary film formed on at least one of the upper surface and the lower surface of the thermochromic film. The sacrificial film may be provided between the thermochromic film and the auxiliary film. The auxiliary film may be an oxide film or a nitride film.

The metal may be at least one selected from the group consisting of titanium (Ti), Nichrome (NiCr), chromium (Cr), nickel (Ni), aluminum (Al), niobium (Nb), zinc (Zn), tin (Sn) and alloys thereof.

In an embodiment, the auxiliary film may be made of titanium dioxide (TiO₂), and the sacrificial film may be made of titanium (Ti).

In an embodiment, the sacrificial film may have a thickness ranging from 1 nm to 5 nm.

According to embodiments of the invention, the sacrificial film made of metal, which is disposed on at least one of the upper and lower surfaces of the thermochromic film, can prevent the thermochromic material from agglomerating during the post-heat-treatment of the substrate, and prevent oxygen and nitrogen in an adjacent layer or the air from diffusing into the thermochromic film, so that high-temperature heat treatment, such as a process for tempering the substrate, a process for heat-strengthening the substrate and a process for forming the substrate to become curved, can be conducted on the substrate.

The methods and apparatuses of the present invention have other features and advantages which will be apparent from, or are set forth in greater detail in the accompanying drawings, which are incorporated herein, and in the following Detailed Description of the Invention, which together serve to explain certain principles of the present invention.

### BRIEF DESCRIPTION OF THE DRAWINGS

FIG. 1 is a schematic cross-sectional view showing a post-heat-treatable substrate according to an embodiment of the invention;

FIG. 2 is a conceptual view schematically showing the state of a substrate of the related art after the substrate is post-heat-treated; and

FIG. 3 is a conceptual view schematically showing the state of a substrate according to an embodiment of the invention after the substrate is post-heat-treated.

### DETAILED DESCRIPTION OF THE INVENTION

Reference will now be made in detail to various embodiments of the present invention, examples of which are illustrated in the accompanying drawings and described below, so that a person having ordinary skill in the art to which the present invention relates can easily put the present invention into practice.

In the following description of the present invention, detailed descriptions of known functions and components incorporated herein will be omitted when they may make the subject matter of the present invention unclear.

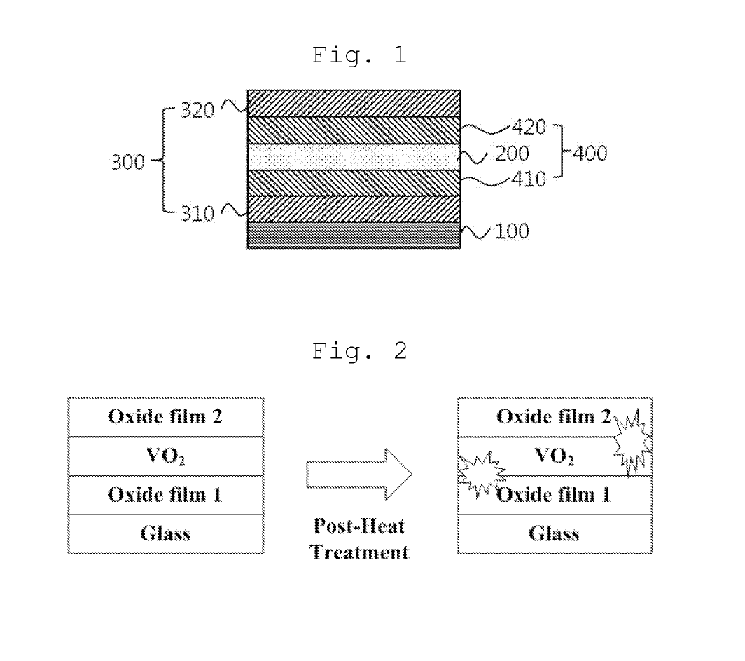

FIG. 1 is a schematic cross-sectional view showing a post-heat-treatable substrate according to an embodiment of the invention.

Referring to FIG. 1, the post-heat-treatable substrate includes a base substrate 100, a thermochromic film 200 formed on the base substrate 100, an auxiliary film 300 formed on at least one of the upper and lower surfaces of the thermochromic film 200, and a sacrificial film 400 formed between the thermochromic film 200 and the auxiliary film 300, the sacrificial film 400 being made of metal.

The base substrate 100 is a transparent or color substrate that has a predetermined area and a predetermined thickness. It is preferred that the base substrate 100 be made of a sodalime glass substrate.

The thermochromic film 200 is formed by coating the base substrate 100 with a material that causes a thermochromic phenomenon, and serves to control the amount of sunlight that is incident on the base substrate 100.

The thermochromic material changes its color at a given temperature. Specifically, the crystalline structure of the thermochromic material changes due to the thermochromic phenomenon to the extent that its physical properties (such as electrical conductivity and infrared (IR) transmittance) rapidly change. Therefore, the coating of the base substrate with the thermochromic material can achieve the effect of blocking IR rays while allowing visible light to enter at the given temperature or higher.

Here, the thermochromic film 200 may be made of one selected from among, but not limited to, vanadium dioxide (VO₂), titanium oxide (III) (TI₂O₃), niobium dioxide (NbO₂), and nickel sulfide (NiS). It is preferred that the thermochromic film 200 be made of VO₂.

The auxiliary film 300 is formed on at least one of the upper and lower surfaces of the thermochromic film 200, and may have the function of improving the optical characteristics or the like of the thermochromic film. By way of example, the auxiliary film may serve as a layer that imparts a low-reflectivity characteristic. In addition, it can also to act to initially block diffusion by preventing the thermochromic film from being directly exposed to the air or the substrate. The auxiliary film 300 may be implemented as an oxide film or a nitride film. As examples thereof, the auxiliary film 300 may be made of one selected from among, but not limited to, silicon dioxide (SiO₂), niobium pentoxide (Nb₂O₅), alumina (Al₂O₃), titanium dioxide (TiO₂) and silicon nitride (Si₃N₄). pm The auxiliary film 300 includes an auxiliary film 310, which is formed on the lower surface of the thermochromic film, and an auxiliary film 320, which is formed on the upper surface of the thermochromic film. The auxiliary films 310 and 320 may be made of the same material or different materials depending on their respective functions. For example, the auxiliary film 310 formed on the lower surface of the thermochromic film may be made of a material that serves to adjust the transmittance and color of the thermochromic film, and the auxiliary film 320 formed on the upper surface of the thermochromic film may be made of a material that serves to protect the thermochromic film. The auxiliary film formed on the base substrate may act as a sodium diffusion barrier, which prevents sodium (Na) ions in the base substrate from diffusing into the thermochromic film at a temperature of 350° C. or higher, which would otherwise deprive the thermochromic film of its characteristics.

The sacrificial film 400 (410, 420) is formed between the thermochromic film 200 and the auxiliary film 300 (310, 320).

The sacrificial film 400 may be made of metal, and be preferably made of one selected from among, but not limited to, titanium (Ti), Nichrome (NiCr), chromium (Cr), nickel (Ni), aluminum (Al), niobium (Nb), zinc (Zn), tin (Sn) and alloys thereof.

The sacrificial layer 400 serves to prevent the atoms in the thermochromic material from diffusing into the upper and lower auxiliary films 310 and 320, and to prevent the elements such as oxygen and nitrogen, which constitute the auxiliary film 300, from diffusing into the thermochromic film 200. The sacrificial layer 400 can also prevent the thermochromic characteristics from being lost and the thermochromic material from agglomerating.

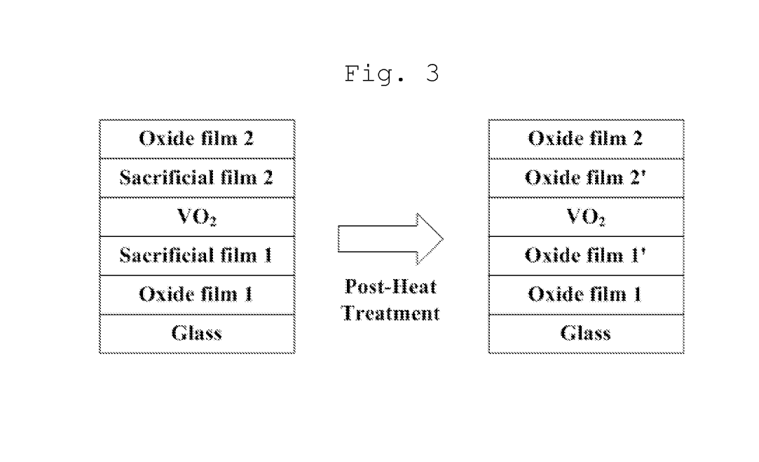

FIG. 2 is a conceptual view schematically showing the state of a substrate of the related art after the substrate is post-heat-treated, and FIG. 3 is a conceptual view schematically showing the state of a substrate according to an embodiment of the invention after the substrate is post-heat-treated.

Referring to FIG. 2 and FIG. 3, when the thermochromic film 200 is a VO₂ thin film and the auxiliary film 300 is an oxide film, the sacrificial film 40 serves to prevent VO₂ atoms from diffusing into the oxide film while being oxidized and thus converted into an oxide film by absorbing oxygen that diffuses from the oxide film. However, the VO₂ film sill acts as an oxygen barrier that enables the oxidation rate to be maintained.

Accordingly, it is possible to solve the problems with the related art, in which a substrate that includes a VO₂ thin film and an oxide film fails to maintain its level of quality as a product because its phase transition characteristic is lost due to the conversion of VO₂ into V₂O₅ by the additional oxidation of VO₂, or because it suffers from the agglomeration of VO₂ due to heat, delamination from an adjacent layer, or discoloration due to the diffusion of substances during the post-heat treatment, such as a process for tempering the substrate, a process for heat-strengthening the substrate and a process for forming the substrate to become curved.

Table 1 presents changes in the quality of coating films, such as Ra (roughness), hazing and defects, after being post-heat-treated.

Post-heat treatment conditions: common vertical furnace (equipment), 700° C.-10 minutes (conditions), atmosphere

TABLE 1

| | Film structure | Ra (nm) | Haze (%) | Defects |
|---|---|---|---|---|
| 1 | Glass/VO₂ | 122 | 7 | Pinhole, |
| | | | | splitting, |
| | | | | haze |
| 2 | Glass/TiO₂/VO₂/TiO₂ | 103 | 5 | Splitting, |
| | | | | haze |
| 3 | Glass/TiO₂/Ti/VO₂/TiO₂ | 41 | 2.1 | Pinhole |
| 4 | Glass/TiO₂/VO₂/Ti/TiO₂ | 29 | 2.3 | Pinhole |
| 5 | Glass/TiO₂/Ti/VO₂/Ti/TiO₂ | 15 | 0.9 | — |
| 6 | Glass/TiO₂/NiCr/VO₂/NiCr/TiO₂ | 21 | 1.2 | — |
| 7 | Glass/TiO₂/Al/VO₂/Al/TiO₂ | 24 | 1.5 | Weak |
| | | | | hazing |

Referring to Table 1, the substrate that has only the VO₂ thin film on the glass base substrate exhibits a roughness of 122 nm and has defects, such as pinholes, splitting and hazing, after being post-heat-treated.

In addition, the substrate that has the TiO₂ auxiliary film, VO₂ thin film and TiO₂ auxiliary film on the glass base substrate exhibits a roughness of 103 nm and has defects, such as splitting and hazing, after being post-heat-treated.

In contrast, the substrate that has the TiO₂ auxiliary film, the Ti sacrificial film, the VO₂ thin film, the Ti sacrificial film, and the TiO₂ auxiliary film exhibits a roughness of 15 nm and does not have defects, after being post-heat-treated.

Accordingly, it is to be appreciated that the sacrificial film decreases the roughness (agglomeration) of the VO₂ thin film and prevents defects from occurring during the post-heat-treatment of the coated substrate.

It is preferred that the sacrificial film have a thickness ranging from 1 nm to 5 nm.

Since the thin sacrificial film is with a thickness ranging from 1 nm to 5 nm, it is completely oxidized or nitrated during the post-heat treatment. Consequently, the sacrificial film can be incorporated into the oxide film or the nitride film, which is above or below, thereby minimizing the optical interference due to the provision of the sacrificial film.

The foregoing descriptions of specific exemplary embodiments of the present invention have been presented with respect to the certain embodiments and drawings. They are not intended to be exhaustive or to limit the invention to the precise forms disclosed, and obviously many modifications and variations are possible for a person having ordinary skill in the art in light of the above teachings.

It is intended therefore that the scope of the invention not be limited to the foregoing embodiments, but be defined by the Claims appended hereto and their equivalents.

1-12. (canceled)

13. A method of manufacturing a thermochromic film coating substrate, the method comprising:
a) preparing a post-heat-treatable substrate;
the post-heat-treatable substrate comprising:
a base substrate;
a thermochromic film coating the base substrate;
at least one of an upper auxiliary film formed on an upper surface of thermochromic film and a lower auxiliary film formed on a lower surface of the thermochromic film, the at least one of the upper and lower auxiliary films being an oxide film or a nitride film:
at least one of an upper sacrificial film formed between the thermochromic film and
the upper auxiliary film and a lower sacrificial film formed between the thermochromic film and the lower auxiliary film, the at least one of the upper and lower sacrificial films being made of metal, and
b) performing post-heat treatment on the post-heat-treatable substrate, the at least one of the upper and lower sacrificial films being completely oxidized or nitratred during the post-heat treatment to be imparted with the same composition as the at least one of the upper and lower auxiliary films.

14. The method of claim 13, wherein the thermochromic film comprises vanadium dioxide (VO₂).

15. The method of claim 13, wherein the oxide film comprises an oxide of the metal and the nitride film comprises a nitride of the metal.

16. The method of claim 15, wherein the at least one of the upper and lower sacrificial films comprises titanium (Ti), and the at least one of the upper and lower auxiliary films comprises titanium dioxide (TiO₂).

17. The method of claim 13, wherein the metal comprises at least one selected from the group consisting of titanium (Ti), Nichrome (NiCr), chromium (Cr), nickel (Ni), aluminum (Al), niobium (Nb), zinc (Zn), tin (Sn) and alloys thereof.

18. The method of claim 13, wherein each of the upper and lower sacrificial films has a thickness ranging from 1 nm to 5 nm.

19. The method of claim 13, wherein the post-heat treatment comprises tempering the post-heat-treatable substrate, heat-strengthening the post-heat-treatable substrate, or forming the post-heat-treatable substrate to become curved.

20. The method of claim 13, wherein the post-heat treatment is carried out in air.
